(19) United States
(12) Patent Application Publication
(10) Pub. No.: US 2020/0126010 A1
(43) Pub. Date: Apr. 23, 2020

(54) Enterprise Business Record Management System

(71) Applicant: SOLIX TECHNOLOGIES, INC., Santa Clara, CA (US)

(72) Inventors: Sai Gundavelli, Santa Clara, CA (US); Vikram Gaitonde, Sunnyvale, CA (US); Mark Lee, Glen Haven, CO (US); Suryanarayana Hota, Rajahmundry (IN); Sudhakara Rao Chandu, Hyderabad (IN)

(73) Assignee: SOLIX TECHNOLOGIES, INC., Santa Clara, CA (US)

(21) Appl. No.: 15/182,618

(22) Filed: Jun. 15, 2016

(51) Int. Cl. G06Q 10/06; G06F 16/182; G06F 16/14; G06F 16/11; G06F 16/13

(52) U.S. Cl. CPC G06Q 10/0637; G06F 16/182; G06F 16/13; G06F 16/125; G06F 16/113; G06F 16/148

(57) ABSTRACT

A record management system includes a front-end system, a processing unit, a database archive, and a search and report terminal in order to create and store enterprise business records. The record management system receives business rules as commands and fetches data from multiple data sources via a network. The record management system creates and stores enterprise business records based on the fetched data. Further, the record management system enables a role-based access to the enterprise business records.

### BACKGROUND

### Field of the Invention

The present invention relates to enterprise data. More particularly, the present invention relates to a record management system that creates, stores, and manages the enterprise data.

### Description of the Related Art

Most organizations need to create and retain business records (hereinafter referred to as records) such as invoices, employment contracts, accounting documents, legal contracts, and the like, for future reference. Traditionally, organizations had a formalized system for retention and destruction of records, which were typically paper records stored in filing cabinets at on-site locations. Further, the paper records were microfilmed and stored at the on-site location along with archival copies stored at an off-site archival location. Such storages incurred high expenses for the organizations for their maintenance and management. The paper records at the off-site archival locations were subjected to degeneration due to pests and environmental changes and they also occupied a lot of space. Furthermore, retrieval of paper and microfilm records was cumbersome.

With advances in information technology, the records have taken a digital form. This paradigm shift has given rise to an increased reliance on electronic documentation of the records in distributed data systems. The distributed data systems, for instance, are database systems deployed within the organizations or outsourced to third party organizations. The records stored in a network of database systems constitute an efficient way of storing the records. Further, the records are stored in a structured format that makes retrieval of the records easy.

Furthermore, as the businesses grow the volume of the records and their interdependencies increase. Management of the records stored at various databases is a serious problem faced by the business organizations, since they have to deal with a large volume of data. For instance, a huge investment is required to ensure efficient management of records when the records are stored in different databases at different locations. The records are often stored in a disjointed fashion, hampering efficient operation of the organization and consuming significant network bandwidth. Further, the existing search technique to access data from the databases is highly inefficient, and due to the absence of a role-based access, security of crucial and confidential data is at risk.

In light of the foregoing discussion, there exists a need for a novel record management system that can efficiently capture information from various data sources, based on business rules, that is deployable and scalable, and that overcomes the aforementioned drawbacks.

### SUMMARY

An object of the present invention is to provide a method and system to create, store, and manage user-defined enterprise business records.

An embodiment of the present invention provides a record management system that includes a front-end system, a processing unit, a database archive, and a search and report terminal. The front-end system includes an enterprise business record modeler. The record management system is connected to data sources via a network. The data sources store business records of an enterprise. A user defines a set of business rules to design enterprise business records through the business record modeler. When the user specifies the set of business rules, the processing unit fetches relevant data from the business records in the data sources. The processing unit also systematizes the fetched data to generate the enterprise business records, based on the set of business rules. The enterprise business records are then indexed and stored in the database archive. Additionally, the record management system enables a role-based access to the enterprise business records in the database archive.

### BRIEF DESCRIPTION OF DRAWINGS

The features of the present invention, which are believed to be novel, are set forth with particularity in the appended claims. Embodiments of the present invention will hereinafter be described in conjunction with the appended drawings provided to illustrate and not to limit the scope of the claims, wherein like designations denote like elements, and in which:

FIG. 1 is a schematic block diagram illustrating an environment in which a record management system is deployed, according to an embodiment of the present invention;

FIG. 2 illustrates a computer system on which various embodiments of the present invention are implemented;

FIG. 3 illustrates an exemplary embodiment of an enterprise business record, according to an embodiment of the present invention;

FIG. 4 illustrates an exemplary embodiment of a modified enterprise business record, according to an embodiment of the present invention; and

FIG. 5 is a flow chart illustrating a method to create the enterprise business record of FIG. 3, according to an embodiment of the present invention.

### DETAILED DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components which constitutes a record management system to create, store, and manage business records. Accordingly, the components and the method steps have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

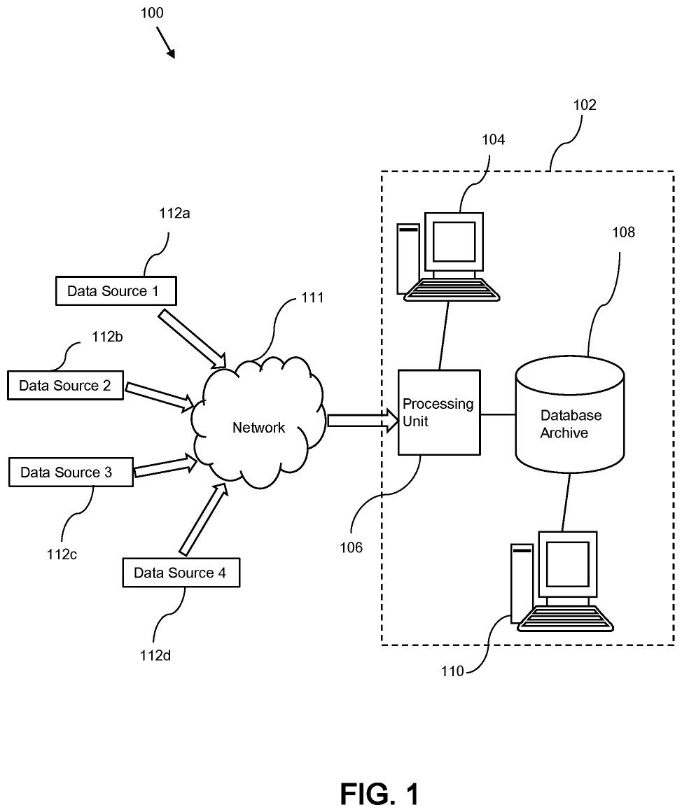

Referring now to FIG. 1, a schematic block diagram illustrating an environment 100 with a record management system 102 deployed therein is shown. The record management system 102 includes a front-end system 104, a processing unit 106, a database archive 108 (also referred to as the memory 108), and a search and report terminal 110 (also referred to as the search terminal 110). The processing unit 106 is connected to a network 111. Examples of the network 111 include a local area network (LAN), a metropolitan area network (MAN), a wide area network (WAN) or the Internet. The processing unit 106 is connected to first through fourth data sources 112a-112d by way of the network 111. The first through fourth data sources 112a-112d are hereinafter referred to as data sources 112, unless specified otherwise. Further, it should be noted by the reader and the practitioner that any number of data sources 112 can be connected to the record management system 102.

The front-end system 104 includes an enterprise business record modeler (not shown) and is communicatively coupled to the processing unit 106, which receives commands from a user by way of the front-end system 104. The processing unit 106 connected to the data sources 112 is configured to fetch data from the data sources 112, based on the commands. Further, the processing unit 106 generates enterprise business records, based on the commands and the fetched data. The processing unit 106 is connected to the database archive 108, which stores the enterprise business records. The database archive 108 is connected to the search and report terminal 110, which is used to access the enterprise business records from the database archive 108.

The data sources 112 may be structured data sources such as relational database management systems (RDBMS), enterprise resource planning (ERP) databases, customer relationship management (CRM) databases, packaged applications, custom applications, and the like. Further, the data sources 112 may be unstructured data sources such as file shares, desktop, laptops, SharePoint sites, File Transfer Protocol (FTP) sites, handheld devices, data on websites, and the like. Data stored in the unstructured data sources does not have a defined data model or a structure. Furthermore, the data sources 112 may also include streaming media sources, print streams, media streams, social media, Internet of Things (IoT), media servers, media files, voice files, digitized data, and the like.

The data stored in the data sources 112 may be business records, industry records and legal hold records. The business records are related to the day-to-day operations of the organization and cover business areas such as, but not limited to, employee management, consultant or contractor management, customer engagements, purchases, sales and contracts. The industry records are specific to a particular industry or a set of industries. Examples of such industry records include medical industry-specific records, food industry-specific records, pharmaceutical industry-specific records, and automobile industry-specific records. Legal hold records are usually mandated by a legal counsel or a personnel handling compliance. The legal hold records need to be held by the organizations to address potential issues associated with compliance audits and litigation.

In an embodiment of the present invention, the processing unit 106 stores the enterprise business records in the database archive 108 by conforming to the Hadoop framework, which includes a Hive over Hadoop Database File System (HDFSor HBASE). Hive facilitates the process of indexing the enterprise business records stored in the HDFS. Further, Hive is also used to run queries on the enterprise business records stored in the HDFS. Further, it should be noted that other non-limiting file systems such as an Apache spark file system, an IBM Netezza file system, an Oracle Exadata file system, a Pivotal Greenplum file system, a File Transfer Protocol (FTP) file system, an Amazon S3 file system, and a Windows Azure Storage Blob (WASB) file system can be implemented in the database archive 108. The record management system 102 may store the data in the database archive 108 in multiple formats, which include, but are not limited to, a comma separated value (CSV), an Apache Parquet, an Optimized Row Columnar (ORC), and an Avro. The enterprise business records may be stored in the database archive 108 conforming to the file formats mentioned above with the required compression. The extent of compression of the enterprise business records is set by the user and performed by software libraries including Snappy, Zlib, and the like.

The search and report terminal 110 allows the user to access and search the enterprise business records stored in the database archive 108. The enterprise business records stored in the database archive 108 are made searchable by using SoIr, Lucene, and Tika engines. Further, the enterprise business records are made reportable through Hive Queries (HQL). It should be noted that searching and reporting functionalities may be implemented on the database archive 108 by using business intelligence tools such as Tableu, Cognos, Datameter, or other non-limiting applications that can access data over open database connectivity (ODBC) or Java database connectivity (JDBC) technology. Moreover, third party applications may use application programming interfaces (APIs) such as JavaScript Object Notation (JSON), JDBC/ODBC, Java, Web Services, and the like, to access the database archive 108.

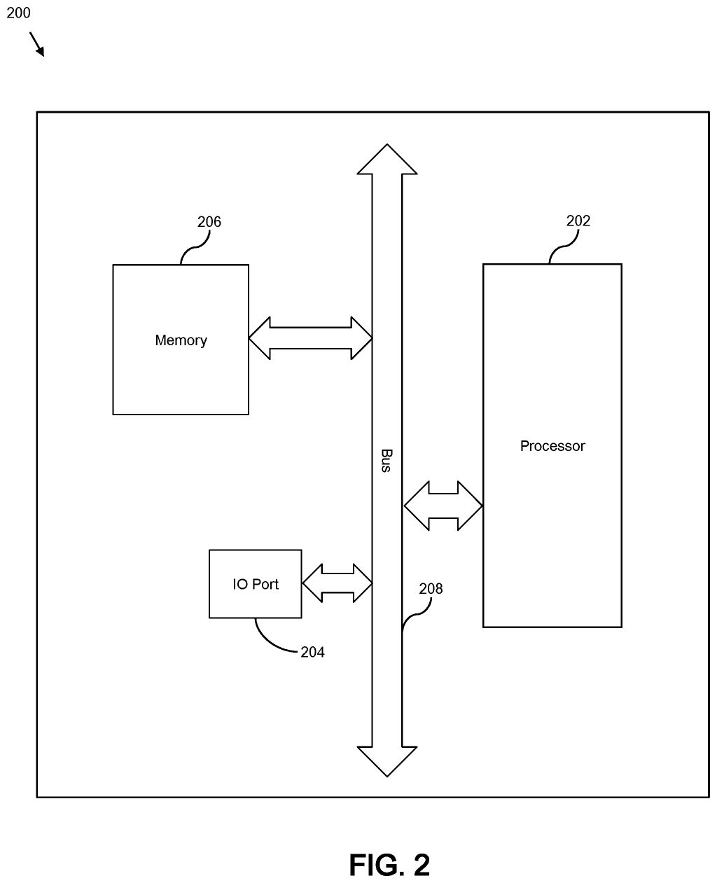

Referring now to FIG. 2, the computer system 200 includes instructions that are required to perform the methodologies described herein. The computer system 200 may be implemented as a server machine or a client machine in a client-server computer network or a peer machine in a peer-to peer or distributed network. The computer system 200 may be realized in the form of a personal computer, a laptop, a server, a set-top box (STB), a tablet, a PDA, a cellular telephone, a web appliance, a server, a network router, a network switch, a network bridge, a video game console, or any machine that is capable of executing a set of computer instructions (sequential or otherwise) that are to be executed by the computer system 200. Further, while only a single computer system 200 is illustrated, the term ‘computer system’ should also be taken to include any collection of records management systems 102 that individually or jointly execute a set (or multiple sets) of instructions to perform any one or more of the methodologies discussed herein.

The computer system 200 includes a processor 202, an input/output (10) port 204, a memory 206 and a system bus 208. The IO port 204 is an interface between the computer system 200 and an external network such as the Internet. The IO port 204 may be connected to input devices such as keyboards, touch-sensitive input devices, microphones, and so on, to accept input from a user. The memory 206 stores sets of instructions to perform the various functions described herein. The IO port 204 and the memory 206 communicate by way of the system bus 208. The processor 202 fetches and executes the sets of instructions from the memory 206.

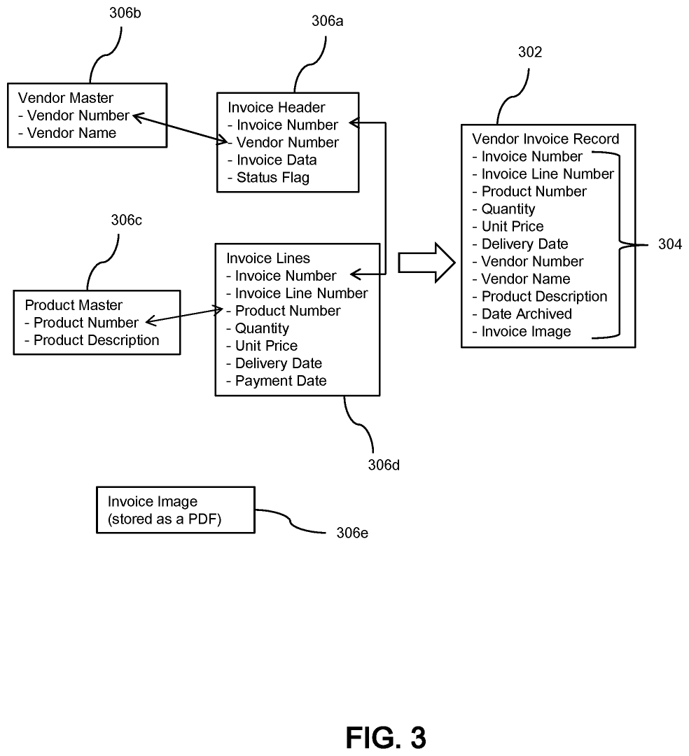

Referring now to FIG. 3, an exemplary embodiment of an enterprise business record 302 created by the record management system 102 is shown. The processing unit 106 creates the enterprise business record 302, based on a set of business rules 304. The enterprise business record 302 includes the data fetched from the data sources 112, which include multiple digital records 306a-306e that include information related to the set of business rules 304. The processing unit 106 parses the digital records 306a-306e to fetch the relevant data.

The record management system 102 registers the data sources 112. The front-end system 104 facilitates registration of the data sources 112. The processing unit 106 registers the data sources 112 using physical address, credentials and connection parameters of the data sources 112. For instance, the processing unit 106 registers the data source 112a by using its IP address, port name, user name, password, and JDBC connection parameters. Subsequent to the registration, the data sources 112 become available to the record management system 102 for data fetching operations. The record management system 102 receives business rules corresponding to which the data is stored in the registered data sources 112. The record management system 102 also receives the business rules from the registered data sources 112 subsequent to the registration of the data sources 112. Further, the record management system 102 generates a list of the business rules. The processing unit 106, based on the business rules, creates logical dependencies and builds relationships between the data sources 112. The business rules form the basis of interdependency of the digital records 306. Further, the user designs the enterprise business record 302 on the enterprise business record modeler by selecting the set of business rules 304, from the list of the business rules, by way of the front-end system 104. Based on the set of business rules 304, the records management system 102 generates a record template, which includes the set of business rules 304. The processing unit 106 fetches the data from the digital records 306a-306e, based on the logical dependencies, and stores the data in the record template. For instance, a vendor number is common to the first digital record 306a and the second digital record 306b. Hence, the first and second digital records 306a and 306b are interdependent and the processing unit 106 fetches the data from the first and second digital records 306a and 306b. The processing unit 106 aggregates the data, based on the interdependency of the digital records 306a-306e. The fetched data includes metadata and content corresponding to the set of business rules 304 as well as table metadata, entity relationships, columns, rows, binary large objects (BLOBs), character large objects(CLOBs), and other attachments pertaining to the set of business rules 304 specified by the user. Furthermore, the processing unit 106 systematizes the fetched data into a user selectable format to create the enterprise business record 302. The format, in which the data is represented in the enterprise business record 302, may be tables, graphs, lists, charts or any other composite format. The enterprise business record 302 is then indexed for easy retrieval, management and reporting purposes. Finally, the record management system 102 provides a role-based access to the enterprise business record 302 stored in the database archive 108. Access rights to the database archive 108 are set by way of the front-end system 104 by the user.

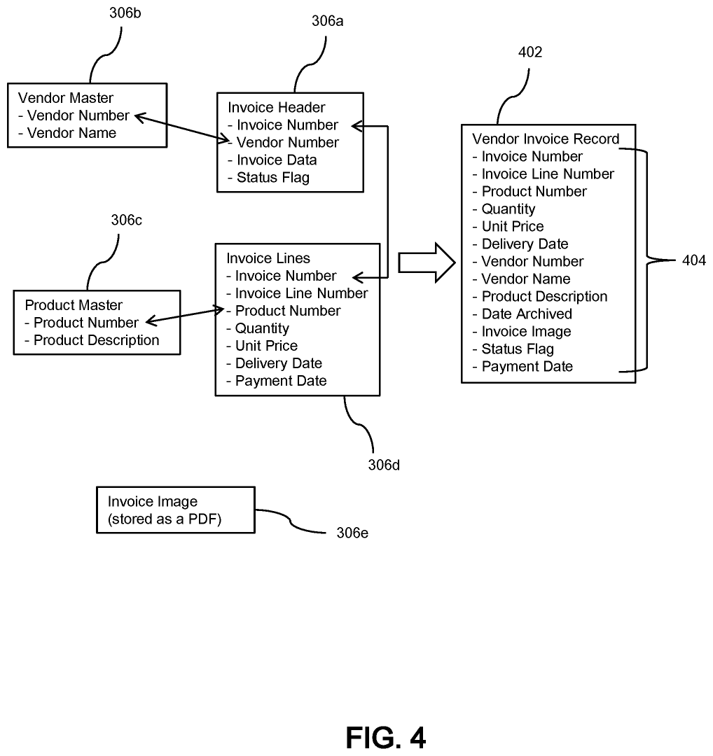

Referring now to FIG. 4, an exemplary embodiment of a modified enterprise business record 402 created by the processing unit 106 of the record management system 102 is shown. The modified enterprise business record 402 includes a modified set of business rules 404. The enterprise business record 302 is modified by way of the enterprise business record modeler to generate the modified enterprise business record 402. Further, based on the modified set of business rules 404, the processing unit 106 fetches the data from the digital records 306a-306e and the modified enterprise business record 402 is generated and stored in the database archive 108.

In an embodiment of the present invention, the user defines the set of business rules 304 and data storage policies by way of the front-end system. The data storage policy includes an archive policy and a retention policy. For instance, if the user selects the set of business rules 304 and defines the archive policy. The processing unit 106 generates the enterprise business record 402 based on the set of business rules 304. The processing unit 106 archives the enterprise business record 402 in the database archive 108. Further, the processing unit 106 validates data pertaining to the archived enterprise business record. The processing unit 106 purges the data corresponding to the validated data from the data source 112. Further, if the user defines the retention policy for the enterprise business record, the data stored in the enterprise business record 402 is purged, based on specific conditions, which can include a time period for which the enterprise business record 402 is stored in the database archive 108, modification to the set of business rules 304, and the like. It should be noted by the reader and the practitioner that the data storage policies are not limited to the archive policy and the retention policy. The invention disclosed herein covers all the data storage policies that are obvious and logical in light of existing record management systems.

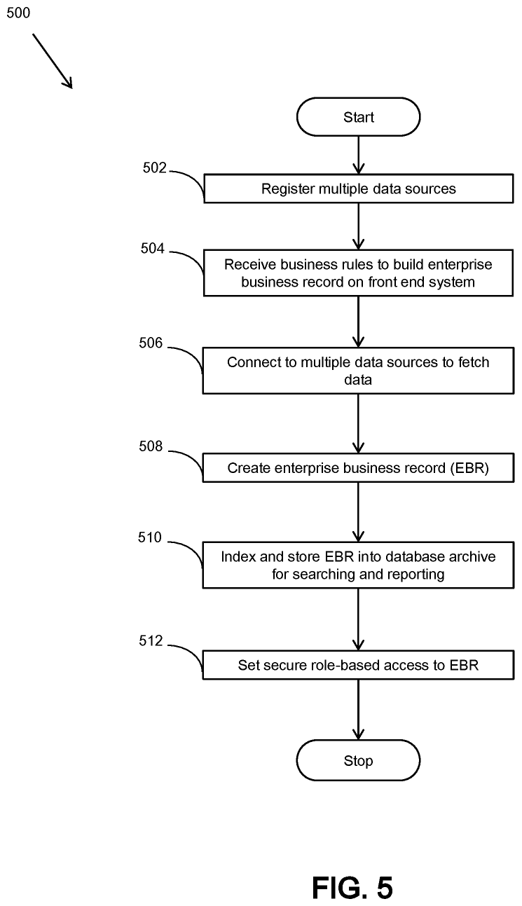

According to an embodiment of the present invention, a method 500 to create and index the enterprise business record 302 is shown in the flowchart in FIG. 5. For clarity, the exemplary method 500 is described with reference to the elements of the record management system 102 depicted in FIG. 1. The order of the steps included in the method 500 may change in practical implementation. Also, certain steps may be deleted, modified, or added to method 500. The steps included in the method 500 may be performed sequentially or in a distributed manner. Further, the steps may involve additional components or omit certain components in practical implementation. At step 502, the record management system 102 registers the data sources 112 by way of the front-end system 104. At step 504, the record management system 102 receives the set of business rules 304 from a user by way of the front-end system 104, and models the enterprise business record 302 by way of the enterprise business modeler. At step 506, based on the set of business rules 304, the processing unit 106 fetches the data from the data sources 112 via the network 111. At step 508, the processing unit 106, based on the set of business rules 304 and the fetched data, creates the enterprise business record 302. The user may specify a customized format for the enterprise business record 302 by way of the front-end system 104. Further, the record management system 102 formats the enterprise business record 302. The processing unit 106 systematizes the fetched data in a pre-defined format to create the enterprise business record 302. At step 510, the record management system 102 indexes and stores the enterprise business record 302 in the database archive 108. The enterprise business record 302 is indexed for easy retrieval, management, and reporting purposes. At step 512, the record management system 102 provides the role-based access to the enterprise business record 302 stored in the database archive 108. The access rights, to the stored enterprise business record 302, are set by way of the front-end system 104 by the user.

In an embodiment of the present invention, the database archive 108 may be deployed in a remote location, and the enterprise business records 302 can be modeled and accessed by way of the front-end system 104 deployed at an accessible location in the organization. In another embodiment, the database archive 108 and the data sources 112 are deployed in a remote location.

Further, the data sources 112 may include applications, which may be custom applications. For instance, the applications may include Enterprise Resource Planning (ERP) software, Customer Relationship Management (CRM) software, and the like. The processing unit 106 fetches the data from such applications in the data sources 112 to create the enterprise business record 302. The fetched data is decoupled from the applications running on the data sources 112. For instance, when the applications are retired, updated, or deleted, the data included in the enterprise business record 302 is not modified or deleted. Thus, the record management system 102 decouples the fetched data from the applications. Further, the record management system 102 can fetch the data from multiple such applications running on the data sources 112 and create the enterprise business record 302.

In another embodiment of the present invention, the record management system 102 creates the enterprise business record 302 for legal audit, governance, and regulatory purposes. The enterprise business record 302 needs to be accurate for such regulatory purposes. To ensure fidelity of data, the processing unit 106 validates the data fetched from the data sources 112. The processing unit 106 uses multiple algorithms such as columns summations, checksums, SHA-1, hash, MD5 hash, and the like, to validate the fetched data.

In yet another embodiment of the present invention, the record management system 102 has searching and reporting capabilities on the enterprise business records 302. Multiple enterprise business records 302 are indexed to facilitate searching and reporting. The enterprise business record 302 may be accessed by way of the search and report terminal 110.

In another embodiment of the present invention, the record management system 102 may provide Information Lifecycle Management (ILM) capabilities such as, but not limited to, legal hold, eDiscovery, and retention management.

The present invention has been described herein with reference to a particular embodiment for a particular application. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claim.

What is claimed is:

1. A record management system for generating and storing an enterprise business record, wherein the enterprise business record includes data corresponding to at least one business rule, and wherein the data corresponding to the at least one business rule is received from a plurality of data sources, the record management system comprising:
a front-end system that receives the at least one business rule and at least one data storage policy and generates a record template, wherein the record template includes the at least one business rule;
a processing unit that is connected to the front-end system for receiving the record template and to the plurality of data sources for receiving the data corresponding to the at least one business rule, generates the enterprise business record based on the record template and the at least one data storage policy, wherein the processing unit creates dependencies between the plurality of data sources based on the at least one business rule, and wherein the enterprise business record includes metadata corresponding to the data received from the plurality of data sources;
a memory that is connected to the processing unit for storing the enterprise business record based on the at least one data storage policy, wherein the processing unit indexes and stores the enterprise business record in the memory, and wherein the memory conforms to a Hadoop Distributed File System; and
a search terminal connected to the memory for accessing the enterprise business record, wherein the search terminal provides role based access to the enterprise business record, and wherein at least one of an Apache SoIr, Apache Tika, and Apache Lucene engine is used to search the enterprise business record stored in the memory.

2. The record management system of claim 1, wherein a data source of the plurality of data sources is at least one of a structured data source and an unstructured data source.

3. The record management system of claim 2, wherein the structured data source includes at least one of a relational database management system (RDBMS), an enterprise resource planning (ERP) database, and a customer relationship management (CRM) database, and wherein the unstructured data source includes at least one of a laptop, a desktop, a handheld device, a SharePoint site, and a File Transfer Protocol (FTP) site.

4. The record management system of claim 1, wherein the at least one data storage policy includes at least one of an archive policy and a retention policy.

5. The record management system of claim 1, wherein the data included in the enterprise business record is de-coupled from the plurality of data sources, and wherein a data source of the plurality of data sources includes at least one of a software application and a streaming media source.

6. The record management system of claim 1, wherein the front-end system includes a database object modeler, and wherein the database object modeler includes a plurality of business rules.

7. The record management system of claim 1, wherein the plurality of data sources are connected to the processing unit by way of a Java Database Connectivity (JDBC) connector framework.

8. The record management system of claim 1, wherein the processing unit receives and compresses the data corresponding to the at least one business rule, wherein the processing unit compresses the data using at least one of a Snappy and a Zlib software, and wherein the compressed data is stored in the enterprise business record.

9. The record management system of claim 1, wherein the processing unit purges the data from the plurality of data sources based on the at least one data storage policy.

10. The record management system of claim 1, wherein the memory conforms to at least one of an Apache spark file system, an IBM Netezza file system, an Oracle Exadata file system, a Pivotal Greenplum file system, an FTP file system, an Amazon S3 file system, and a Windows Azure Storage Blob (WASB) file system.

11. A method to generate and store an enterprise business record by a record management system, wherein the enterprise business record includes data corresponding to at least one business rule, and wherein the data corresponding to at least one business rule is received from a plurality of data sources, the method comprising:
receiving the at least one business rule and at least one data storage policy by way of a front-end system;
generating a record template by the front-end system, wherein the record template includes the at least one business rule;
generating the enterprise business record based on the record template and the at least one data storage policy by the processing unit, wherein the processing unit creates dependencies between the plurality of data sources based on the at least one business rule, and wherein the enterprise business record includes metadata corresponding to the data received from the plurality of data sources; and
storing the enterprise business record in a memory by the processing unit, wherein the processing unit indexes and stores the enterprise business record in the memory, and wherein the memory conforms to a Hadoop Distributed File System.

12. The method of claim 11 further comprising:
searching the enterprise business record stored in the memory by way of a search terminal, wherein the search terminal provides a role based access to the enterprise business record, and wherein at least one of an Apache SoIr, Apache Tika, and Apache Lucene engine is used to search the enterprise business record stored in the memory.

13. The method of claim 11, wherein a data source of the plurality of data sources is at least one of a structured data source or an unstructured data source.

14. The method of claim 13, wherein the structured data source includes at least one of a relational database management system (RDBMS), an enterprise resource planning (ERP) database, and a customer relationship management (CRM) database, and wherein the unstructured data source includes at least one of a laptop, a desktop, a handheld device, a SharePoint site, and a File Transfer Protocol (FTP) site.

15. The method of claim 11, wherein the at least one data storage policy includes at least one of an archive policy and a retention policy.

16. The method of claim 11, wherein the data included in the enterprise business record is de-coupled from the plurality of data sources, and wherein a data source of the plurality of data sources includes at least one of a software application and a streaming media source.

17. The method of claim 11, wherein the front-end system includes a database object modeler, and wherein the database object modeler includes a plurality of business rules.

18. The method of claim 11, wherein the processing unit receives and compresses the data corresponding to the at least one business rule, wherein the processing unit compresses the data using at least one of a Snappy and a Zlib software, and wherein the compressed data is stored in the enterprise business record.

19. The method of claim 11, wherein the processing unit purges the data from the plurality of data sources based on the at least one data storage policy.

20. The method of claim 11, wherein the memory conforms to at least one of an Apache spark file system, an IBM Netezza file system, an Oracle Exadata file system, a Pivotal Greenplum file system, an FTP file system, an Amazon S3 file system, and a Windows Azure Storage Blob (WASB) file system.
